(19) United States
(12) Patent Application Publication
(10) Pub. No.: US 2025/0012122 A1
(43) Pub. Date: Jan. 9, 2025

(54) CLOSURE LATCH ASSEMBLY WITH RELEASE MECHANISM HAVING DECOUPLED PAWL SENSOR ARRANGEMENT

(71) Applicant: MAGNA CLOSURES INC., Newmarket (CA)

(72) Inventors: Kar Wang WOO, Newmarket (CA); Neil GUILLERMO, Newmarket (CA); Danny CHIK, Newmarket (CA)

(21) Appl. No.: 18/762,417

(22) Filed: Jul. 2, 2024

Related U.S. Application Data
(60) Provisional application No. 63/525,352, filed on Jul. 6, 2023.

(51) Int. Cl. E05B 81/68; E05B 79/02; E05B 81/14; E05B 83/36

(52) U.S. Cl. CPC E05B 81/68; E05B 79/02; E05B 81/14; E05B 83/36

(57) ABSTRACT

A latch assembly for a closure panel includes a housing member and a ratchet configured for movement relative to the housing member between a striker capture and striker release positions. A pawl is configured for movement relative to the housing member between a ratchet holding position, whereat the pawl maintains the ratchet in the striker capture position, and a ratchet releasing position, whereat the pawl releases the ratchet for movement of the ratchet to the striker release position. A pawl sensor assembly includes a first sensor member fixed relative to the housing member and a second sensor member movable from a first position to a second position. The first position indicates the pawl in the ratchet holding position, and the second position indicates the pawl in the ratchet releasing position. The second member is moveable relative to the pawl and the housing member.

### CROSS-REFERENCE TO RELATED APPLICATION

This application claims the benefit of U.S. Provisional Application Ser. No. 63/525,352, filed Jul. 6, 2023, which is incorporated herein by reference in its entirety.

### FIELD

The present disclosure relates generally to closure latch assemblies for use in motor vehicle closure systems. More specifically, the present disclosure is directed to a closure latch assembly for a vehicle closure panel having a pawl sensor arrangement.

### BACKGROUND

This section provides background information related to the present disclosure which is not necessarily prior art.

Closure panels of motor vehicles typically have latch assemblies configured to maintain the closure panel in a closed position when desired, with the latch assemblies being selectively moveable to release the closure member for movement to an open position. Generally, a latch assembly has a pawl configured to move to a ratchet holding position to maintain a ratchet in a striker capture position, whereat the closure member is maintained in its closed position, and to a ratchet releasing position to allow the ratchet to move to a striker release position, whereat the closure member can be moved to its open position. Modern vehicle systems typically have a sensor arrangement to detect when the pawl is in the ratchet holding position and the ratchet releasing position to facilitate proper operation of the latch assembly and to indicate to a user the state of the latch assembly, whether latched or unlatched. Typically, a magnet or other feature is fixed directly to the pawl, such that movement of the pawl, and thus the magnet or feature, can be detected by a sensor. Although effective to indicate the position of the pawl, unwanted movement of the pawl from the ratchet holding position to the ratchet releasing position could occur if the magnet or feature fixed thereto is impacted by an unforeseen impact force, such as during a crash condition.

In view of the above, there remains a need to develop a latch assembly and pawl sensor arrangement therefor which addresses and overcome limitations and drawbacks associated with known pawl sensor arrangements and latch assemblies therewith.

### SUMMARY

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

In one aspect, the present disclosure is directed to a latch assembly for a closure panel, with the latch assembly having a pawl that resists being inadvertently moved from a ratchet holding position to a ratchet releasing positon during a crash condition when a housing member of the latch assembly is deformed.

In another aspect, the present disclosure is directed to a method of constructing a latch assembly having a pawl that resists being inadvertently moved from a ratchet holding position to a ratchet releasing positon during a crash condition when a housing member of the latch assembly is deformed.

It is a related aspect to provide a latch assembly that is reliable, compact, and economical in manufacture, assembly, and in use.

In accordance with these and other aspects, a latch assembly for a closure panel includes a housing member and a ratchet configured for movement relative to the housing member between a striker capture position and a striker release position. The ratchet is biased toward the striker release position. Further included is a pawl configured for movement relative to the housing member between a ratchet holding position, whereat the pawl maintains the ratchet in the striker capture position, and a ratchet releasing position, whereat the pawl releases the ratchet for movement of the ratchet to the striker release position. Further includes is a sensor assembly with a first sensor member fixed relative to the housing member and a second sensor member movable from a first position to a second position. When in the first position, the sensor assembly indicates the pawl in the ratchet holding position, and when in the second position, the sensor assembly indicates the pawl in the ratchet releasing position. The second sensor member is moveable relative to the pawl and the housing member.

A latch assembly for a closure panel includes a housing member, a ratchet configured for movement relative to said housing member between a striker capture position and a striker release position and biased toward said striker release position, a pawl configured for movement relative to said housing member between a ratchet holding position, whereat said pawl maintains said ratchet in said striker capture position, and a ratchet releasing position, whereat said pawl releases said ratchet for movement of said ratchet to said striker release position, and a pawl sensor assembly coupled to the pawl in lost motion, wherein the lost motion coupling is configured to prevent movement of the pawl sensor imparting a corresponding movement to the pawl.

In accordance with a further aspect of the disclosure, a method of constructing a latch assembly for a closure panel is provided. The method includes a step of providing a housing member and supporting a ratchet for movement relative to the housing member between a striker capture position and a striker release position, with the ratchet being biased toward the striker release position. A further step includes supporting a pawl for movement relative to the housing member between a ratchet holding position, whereat the pawl maintains the ratchet in the striker capture position, and a ratchet releasing position, whereat the pawl releases the ratchet for movement of the ratchet to the striker release position. Further, a step of fixing a first sensor member of a pawl sensor assembly relative to the housing member, and supporting a second sensor member of the pawl sensor assembly for movement relative to the first sensor member from a first position to a second position, such that when the second sensor member is in the first position, the pawl sensor assembly indicates the pawl is in the ratchet holding position, and when the second sensor member is in the second position, the pawl sensor assembly indicates the pawl is in the ratchet releasing position.

In accordance with a further aspect, the method can further include a step of arranging a biasing member to bias the second sensor member toward the first position.

In accordance with a further aspect, the method can further include a step of arranging the second sensor member to engage and bias the pawl toward the ratchet holding position under the bias imparted by the biasing member.

In accordance with a further aspect, the method can further include a step of arranging a pawl release lever for movement from a non-deployed position, whereat the pawl is in the ratchet holding position, to a deployed position, whereat the pawl is moved conjointly with the second sensor member against the bias imparted by the biasing member to the ratchet releasing position, whereat the second sensor member communicates with the first sensor member to indicate the pawl being in the ratchet releasing position.

In accordance with a further aspect, the method can further include a step of arranging the pawl release lever to engage the pawl during movement from the non-deployed position to the deployed position.

In accordance with a further aspect, the method can further include a step of arranging the second sensor member for movement toward the second position against the bias of the biasing member while the pawl remains in the ratchet holding position.

In accordance with a further aspect, the method can further include a step of providing a carrier supporting a rolling element and arranging the rolling element for rolling action between the ratchet and the pawl.

In accordance with a further aspect, the method can further include a step of arranging a first bumper to prevent the rolling element from impacting the pawl during movement of the pawl from the ratchet releasing position to the ratchet holding position.

In accordance with a further aspect, the method can further include a step of arranging a second bumper to prevent the rolling element from contacting the pawl after movement of the pawl to the ratchet releasing position.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. Other advantages of the present embodiments than discussed expressly herein will be readily appreciated, as the same becomes better understood by reference to the following detailed description and appended claims when considered in connection with the accompanying drawings, wherein:

FIG. 1 is a perspective view of an example motor vehicle equipped with a latch assembly for a closure panel according to an aspect of the disclosure;

FIGS. 2A and 2B are perspective views of an example embodiment of a latch assembly having a pawl and pawl sensor assembly constructed according to an aspect of the disclosure;

FIG. 3 is a plan view of an example embodiment of a latch assembly having a pawl and pawl sensor assembly constructed according to an aspect of the disclosure;

FIG. 4A is a perspective view of the latch assembly of FIG. 3 illustrating a power release;

FIG. 4B is a perspective view of the latch assembly of FIG. 3 illustrating a manual release;

FIG. 5A is a perspective view of an example embodiment of a latch assembly having a pawl and pawl sensor assembly constructed according to an aspect of the disclosure, shown while being impacted by force in a crash condition causing the feature of a latch housing to be moved into a blocking position to prevent inadvertent movement of the pawl;

FIG. 5B is a perspective view similar to FIG. 5B illustrating a force causing a member of the pawl sensor assembly to be moved relative to the pawl, with the pawl remaining in a ratchet holding position;

FIG. 6 is a plan view illustrating operation of the latch housing moving into a blocking position;

FIG. 7 is another possible configuration of the latch of FIG. 2A illustrating a bumper assembly for the pawl assembly; and

FIG. 8 illustrates a flow diagram of a method.

Corresponding reference numerals indicate corresponding parts throughout the several views of the drawings.

### DETAILED DESCRIPTION OF EXAMPLE EMBODIMENTS

An example embodiment of a power actuator for a motor vehicle closure panel and method of inhibiting binding movement of an extensible rack thereof will now be described more fully with reference to the accompanying drawings. To this end, the example embodiment of a power actuator is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

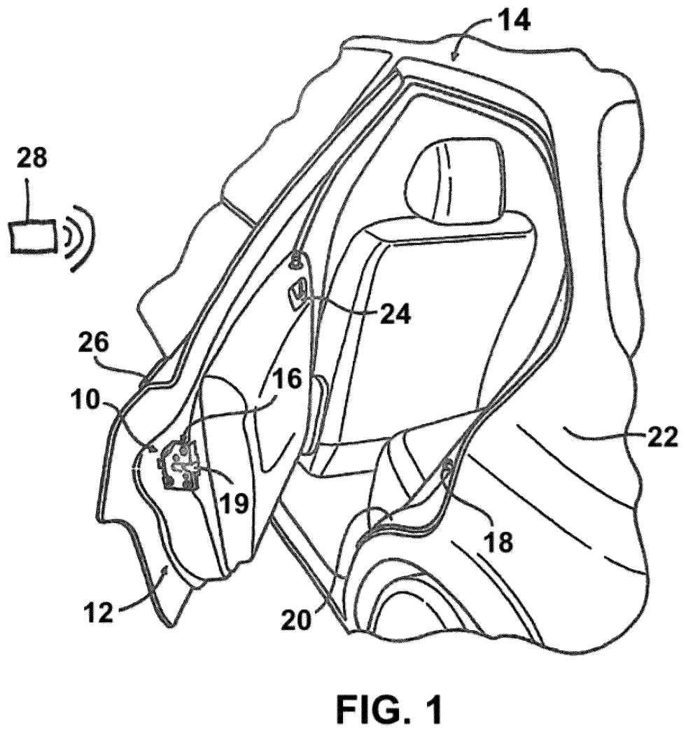

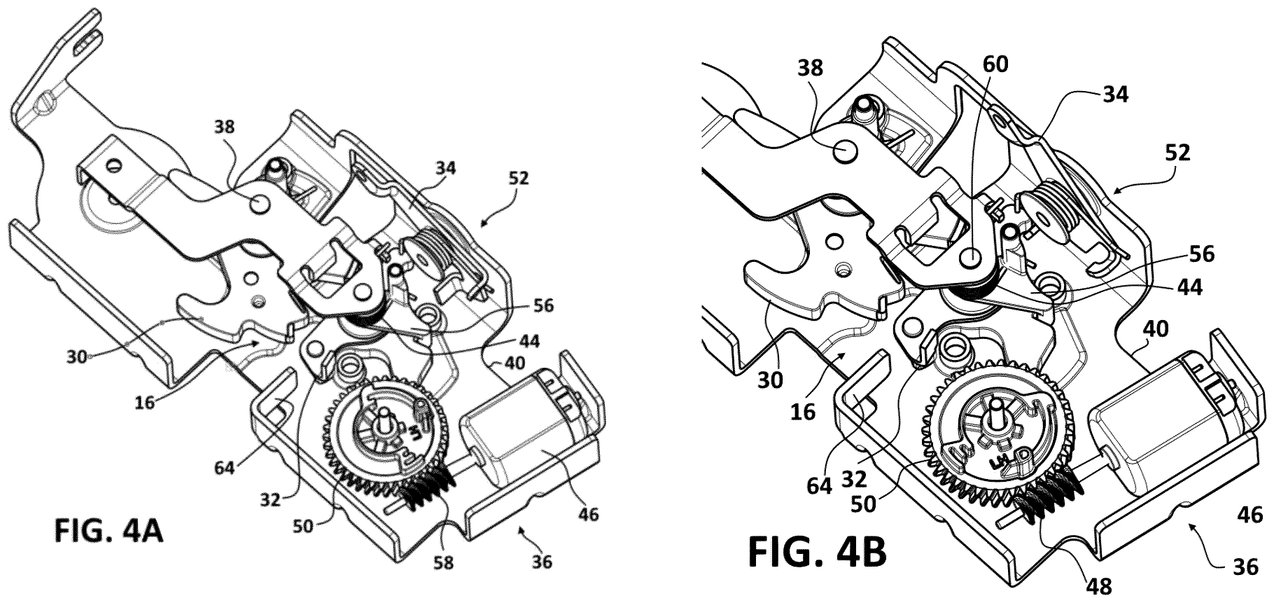

Referring initially to FIG. 1, a non-limiting example of a power latch assembly, referred to hereafter simply as latch assembly 10 installed in a closure panel, such as, by way of example and without limitation, a passenger side swing door 12 of a motor vehicle 14, is shown. Latch assembly 10 includes a latch mechanism 16 configured to releasably latch and hold a striker 18 mounted to a fixed sill portion 20 of vehicle body 22 when swing door 12 is closed. Latch assembly 10 can be selectively actuated via an inside door handle 24, an outside door handle 26, and a key fob 28. As will be detailed, latch assembly 10 is configured in a non-limiting embodiment to be power-operated in a normal use state and under normal conditions (FIG. 4A), with inside door handle 24 remaining mechanically disengaged while in a child lock state and outside door handle 26 remaining mechanically disengaged during normal use conditions, such that the inside door handle 24 and outside door handle 26 are normally ineffective for mechanical actuation of latch mechanism 16 during a child lock state and while in normal use. However, the inside door handle 24 can be selectively mechanically coupled with latch mechanism 16, such as via selective actuation by a vehicle driver or occupant having access to an actuation device (not shown), e.g. button in proximity to the vehicle driver, as may be desired to override the child lock state of a rear passenger door, by way of example and without limitation, and inside door handle 24 and outside door handle 26 can be configured to be automatically mechanically coupled with latch mechanism 16, such that latch mechanism 16 can be manually and mechanically actuated via inside door handle 24 and outside door handle 26 (FIG. 4B), when desired, and thereafter, inside door handle 24 and outside door handle 26 can be selectively and automatically returned to their respective normal use positions.

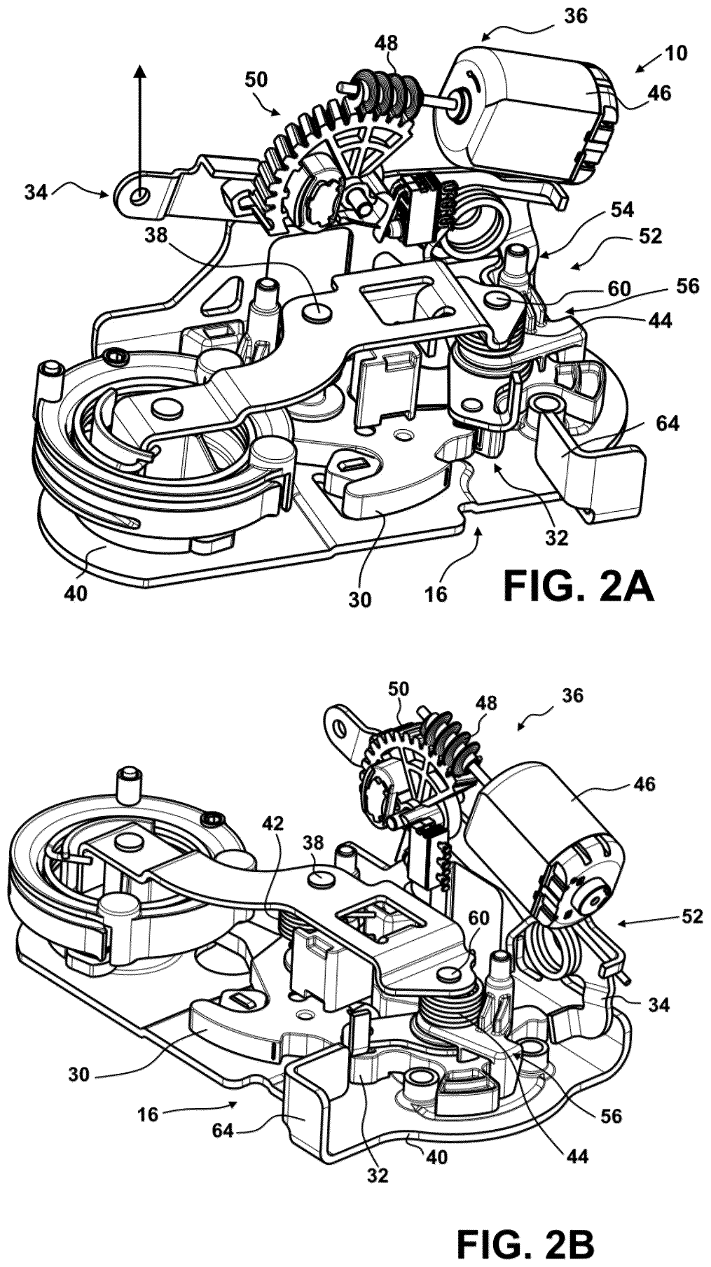

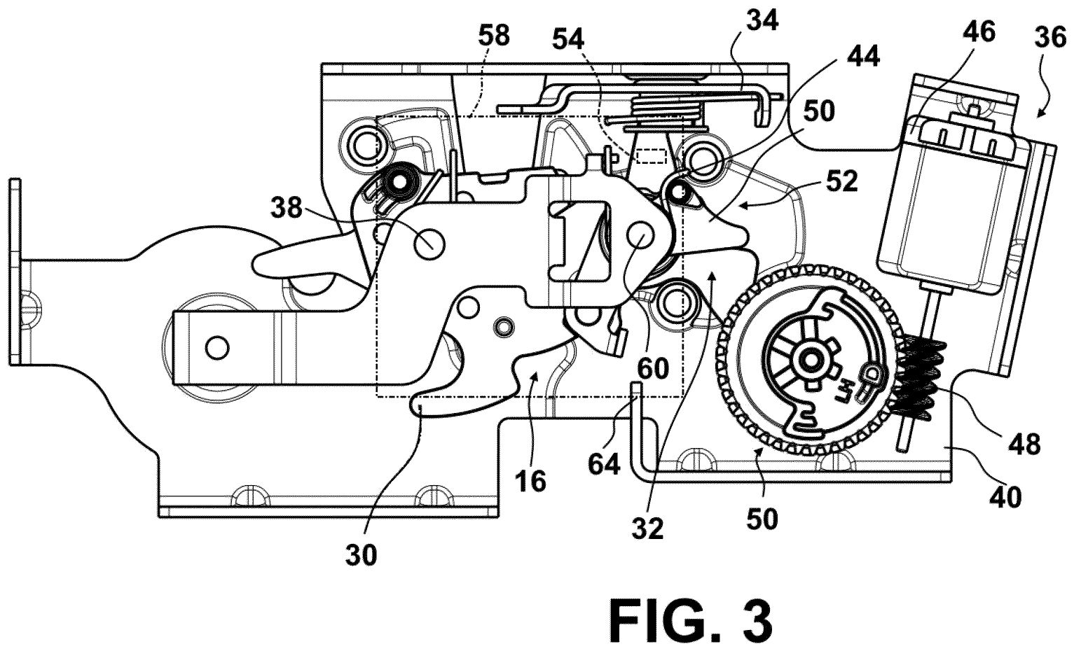

Referring to FIGS. 2A and 2B, shown is a non-limiting embodiment of latch assembly 10 and latch mechanism 16, with some components removed for clarity purposes only, having a ratchet 30 and a pawl 32, a latch release mechanism including a release lever 34, for selective mechanical and/or power operation, a power release actuator system 36 for controlling powered actuation of the latch release mechanism 16.

Ratchet 30 is supported for rotation on a ratchet rivet or pin 38 for movement between a striker capture position (FIGS. 2A and 2B), whereat ratchet 30 retains striker 18 and swing door 12 in closed position, and a striker release position (FIG. 1) whereat ratchet 30 permits release of striker 18 from a fishmouth 19 provided by a latch housing, including a latch plate, also referred to as housing plate, frame plate or housing member 40, of latch assembly 10 to allow movement of swing door 12 to the open position. A ratchet biasing member 42, such as a spring, is supported on ratchet pin 38 to normally bias ratchet 30 toward its striker release position. Pawl 32 is movable between a ratchet holding position, whereat pawl 32 holds ratchet 30 in its striker capture position, and a ratchet releasing position, whereat pawl 32 permits ratchet 30 to move to its striker release position under the bias imparted by ratchet biasing member 42. A biasing member 44, such as a suitable spring, is provided to normally and indirectly bias pawl 32 toward its ratchet holding position.

Power release actuator system 36 includes a motor, referred to as power release motor 46, having an output shaft, with a drive gear, also referred to as power release gear, shown as a power release worm 48 mounted on output shaft, by way of example and without limitation, and a power release gear, also referred to as worm gear 50. Actuation of power release motor 46 operably drives pawl 32 from its ratchet holding position to its ratchet releasing position, when desired.

Power release actuator system 36 can be used as part of a conventional passive keyless entry feature. When a person approaches vehicle 14 with electronic key fob 28 and actuates the outside door handle 26, for example, sensing both the presence of key fob 28 and that outside door handle 26 has been actuated, wherein inside door handle 24 also is actuatable and a latch electronic control unit (not shown) that at least partially controls the operation of latch assembly 10. Power release actuator system 36 can be alternatively activated as part of a proximity sensor based entry feature (radar based proximity detection for example), for example when a person approaches vehicle 14 with electronic key fob 28 and actuates a proximity sensor, such as a capacitive sensor, or other touch/touchless based sensor (based on a recognition of the proximity of an object, such as the touch/swipe/hover/gesture or a hand or finger), (e.g. via communication between the proximity sensor and latch ECU that at least partially controls the operation of latch assembly 10). In turn, if detecting a normal use condition, such as the presence of electronic key fob 28, by way of example and without limitation, latch ECU actuates power release actuator system 36 to release the latch mechanism 16 and shift latch assembly 10 into an unlatched operating state so as to facilitate subsequent opening of vehicle door 12.

Latch assembly 10 further includes a pawl sensor assembly 52 with a first sensor member 54 fixed relative to said housing member 40 and a second sensor member 56 movable from a first position to a second position. When the second sensor member 56 is in the first position, the sensor assembly 50 indicates, such as to ECU, the pawl 32 is in the ratchet holding position. When the second sensor member 56 is in the second position, the sensor assembly 52 indicates the pawl 32 is in the ratchet releasing position. The second sensor member 56 is moveable relative to the first sensor member 52, the pawl 32, and the housing member 40.

First sensor member 54 and second sensor member 56 can be provided as Hall sensor arrangement, by way of example and without limitation. First sensor member 54, which is fixed relative to housing member 40, can be provided on a PCB in communication with the PCB or in communication with a remote PCB, wherein the PCB can be configured in communication with ECU. Any desired source of communication can be arranged, such as wires, traces, or wireless. Second sensor member 56 can be arranged for pivotal movement about a common axis of rotation as pawl 32, such that both pawl 32 and second sensor member 56 can be supported for pivotal movement on and about a pawl pin 60. Biasing member 44 is configured to bias the second sensor member 56 toward the first position and into engagement with pawl 32 toward the ratchet holding position. Accordingly, biasing member 44 acts directly on second sensor member 56, and second sensor member 56 engages and acts directly on pawl 32, thereby causing pawl 32 to be biased toward the ratchet holding position indirectly under the bias of biasing member 44. Accordingly, pawl 32 does not have a spring type pawl biasing member acting direction thereon, as second sensor member 56 functions to directly engage and bias pawl 32 toward the ratchet holding position under the bias imparted by biasing member 44 directly on second sensor member 56.

During a release operation, as best shown in FIG. 2B, release lever 34 can act directly on pawl 32 to impart a sufficient force to overcome the bias imparted by biasing member 44, thereby causing both pawl 32 to be moved to the ratchet releasing position, and second sensor member 56 to be moved to the second position, whether via power release (FIG. 4A) or manual release (FIG. 4B). Of course, during the release operation, pawl 32 acts directly on second sensor member 56, and second sensor member 56 acts directly on biasing member 44 to overcome the bias imparted by biasing member 44 directly on second sensor member 56 and indirectly on pawl 32. Release lever 34 is moveable via powered actuation and/or manual actuation from a non-deployed position, whereat pawl 32 is in the ratchet holding position, under the indirect bias imparted by biasing member 44, to a deployed position, whereat the pawl 32 is moved conjointly with second sensor member 56, overcoming the bias imparted by biasing member 44, to the ratchet releasing position. When second sensor member 56 is in the second position, second sensor member 56 communicates magnetically/electrically with first sensor member 54, whereupon first sensor member 54 communicates with ECU to indicate pawl 32 is in the ratchet releasing position.

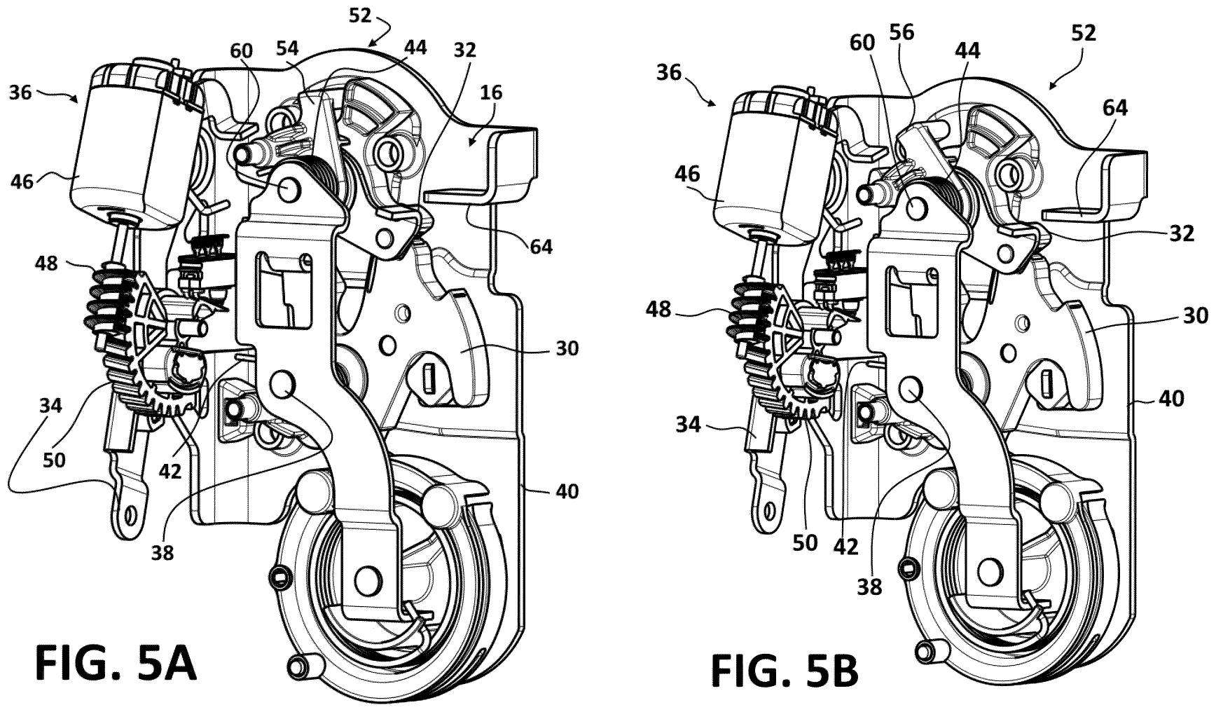

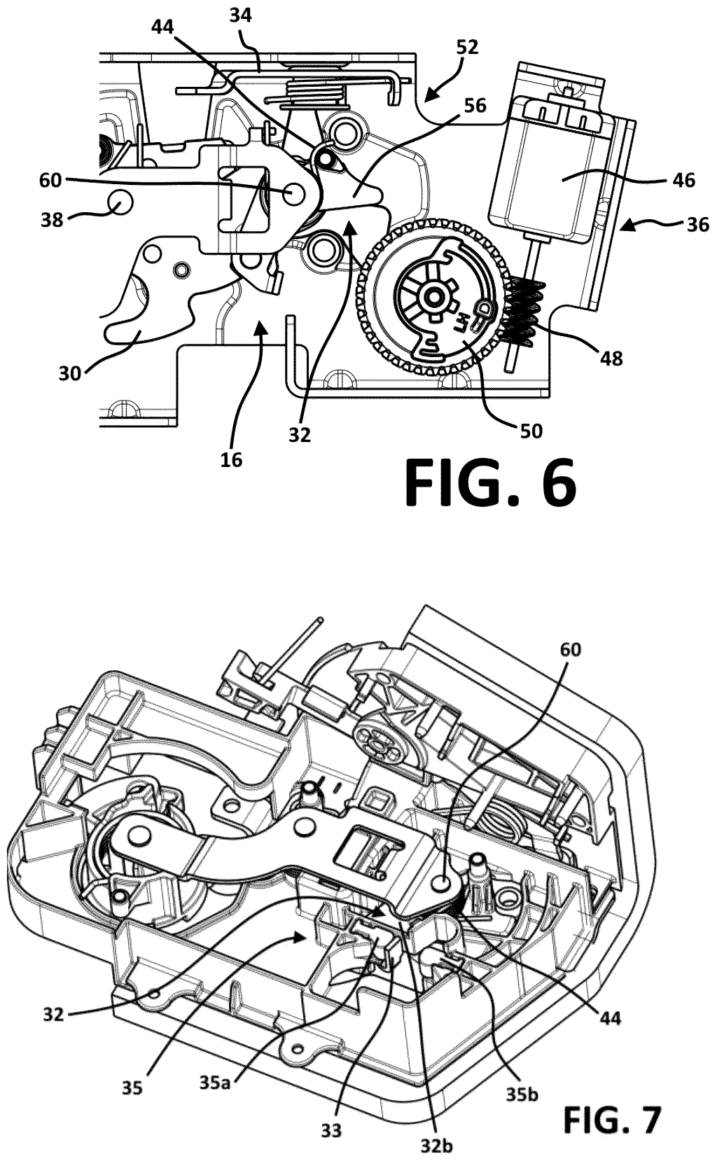

With biasing member 44 acting directly on second sensor member 56, second sensor member 56 is moveable toward the second position while the pawl 32 remains in the ratchet holding position. Accordingly, second sensor member 56 is moveable relative to pawl 32. This can prove important during a crash condition, particularly when the motor vehicle 14 encounters an impact to the door 12 causing the housing member 40 to become damaged, also referred to as displaced or deformed. If displaced components or material of the housing member 40 impact the second sensor member 56, the second sensor member 56 is free to move relative to pawl 32 against the bias of biasing member 44 to the second position (FIG. 5B) without causing or requiring pawl 32 to move from the ratchet holding position. Accordingly, the pawl 32 is not inadvertently caused to move from the ratchet holding position when the second sensor member 56 moves against the bias of biasing member 44 under forcible engagement with the displaced housing member 40, thereby avoiding an inadvertent release of latch assembly 10. Further yet, housing member 40 can be provided having a pawl blocking feature 64 (FIGS. 5A and 6), such that when the housing member 40 is deformed or displaced in the crash condition, the pawl blocking feature 64 can be moved into blocking arrangement with pawl 32, thereby preventing inadvertent movement of pawl 32 away from the ratchet holding position.

Now referring to FIG. 7, in addition to FIG. 2A, a pawl assembly 32′ is configured having a pawl 32a and a carrier 32b. Carrier 32b is configured to support a rolling element 32c so as to position the rolling element 32c for rolling action between the ratchet 30 and the pawl 32a. During release of the pawl 32a, as pawl 32a is being moved away from the ratchet 30 to release the latch mechanism 16, a rolling action of the rolling element 32c will be induced by rolling contact with ratchet 30 via at least one of the movement of the pawl 32a and the ratchet 30. As rolling is induced on the rolling element 32c, the rolling element 32c will cause the carrier 32b to be pivoted about the pawl pivot post 56 in a counterclockwise direction when viewed in FIG. 7. A bumper assembly 35 may be provided so as to limit the travel or rotation of the carrier 32a. Carrier 32b comprises an upstanding flange 33 configured to engage the bumper assembly 35 to hinder motion of the carrier 32b. For example, bumper assembly 35 can include two bumpers, referred to as first bumper 35a and second bumper 35b, to control the end positions to provide limits to a range of motion of the carrier 32b. The housing member 40 may be configured to support the bumper assembly 35. Second bumper 35b may be provided to absorb the impact noise of the carrier 32b and/or prevent the rolling element 32 from contacting the pawl 32a after release, thereby reducing noise and impact damage to the rolling element 32c. Similarly, first bumper 35a may be provided to absorb the impact noise of the carrier 32b and/or prevent the rolling element 32c from impacting the pawl 32a during reset or return of the pawl 32a to the ratchet holding position and prevent the rolling element 32c from impacting the ratchet 30 to prevent damage to the roller 32c.

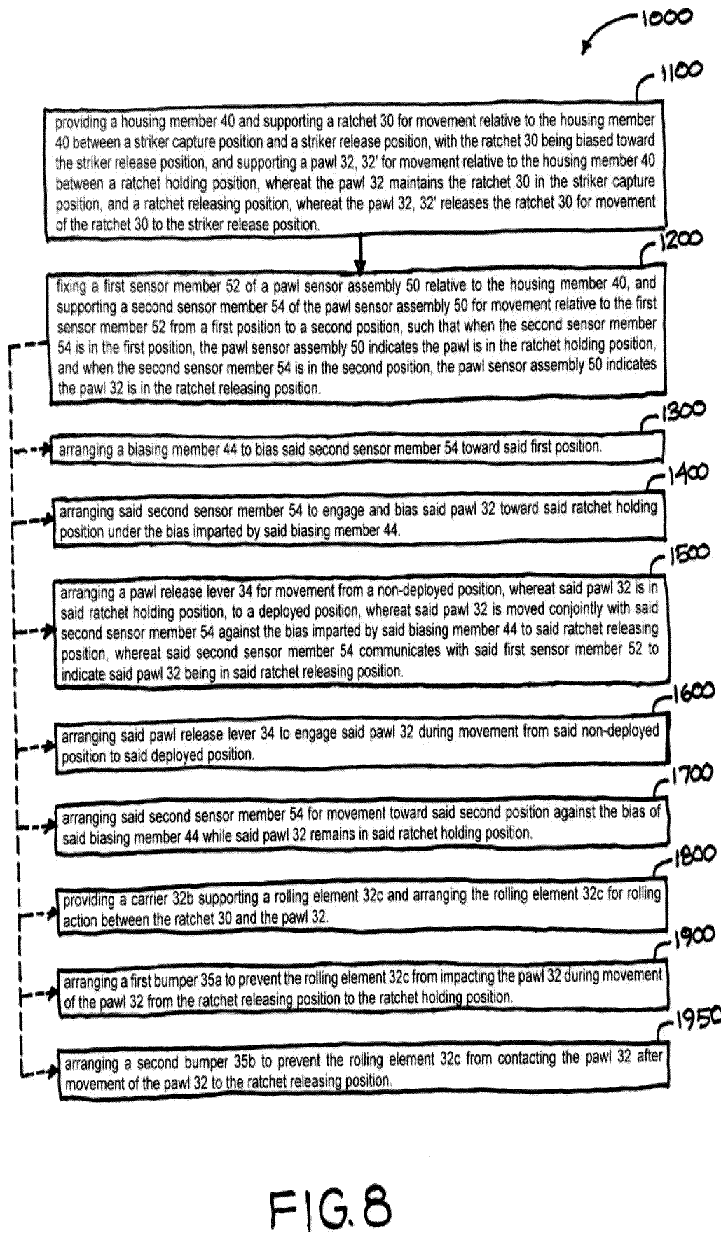

In accordance with a further aspect of the disclosure, as illustrated in FIG. 8, a method 1000 of constructing a latch assembly 10 for a closure panel 12 is provided. The method 1000 includes a step 1100 of providing a housing member 40 and supporting a ratchet 30 for movement relative to the housing member 40 between a striker capture position and a striker release position, with the ratchet 30 being biased toward the striker release position. Step 1100 further includes supporting a pawl 32, 32′ for movement relative to the housing member 40 between a ratchet holding position, whereat the pawl 32 maintains the ratchet 30 in the striker capture position, and a ratchet releasing position, whereat the pawl 32, 32′ releases the ratchet 30 for movement of the ratchet 30 to the striker release position. Further, a step 1200 of fixing a first sensor member 52 of a pawl sensor assembly 50 relative to the housing member 40, and supporting a second sensor member 54 of the pawl sensor assembly 50 for movement relative to the first sensor member 52 from a first position to a second position, such that when the second sensor member 54 is in the first position, the pawl sensor assembly 50 indicates the pawl is in the ratchet holding position, and when the second sensor member 54 is in the second position, the pawl sensor assembly 50 indicates the pawl 32 is in the ratchet releasing position.

In accordance with a further aspect, the method 1000 can further include a step 1300 of arranging a biasing member 44 to bias the second sensor member 54 toward the first position.

In accordance with a further aspect, the method 1000 can further include a step 1400 of arranging the second sensor member 54 to engage and bias the pawl 32 toward the ratchet holding position under the bias imparted by the biasing member 44.

In accordance with a further aspect, the method 1000 can further include a step 1500 of arranging a pawl release lever 34 for movement from a non-deployed position, whereat the pawl 32 is in the ratchet holding position, to a deployed position, whereat the pawl 32 is moved conjointly with the second sensor member 54 against the bias imparted by the biasing member 44 to the ratchet releasing position, whereat the second sensor member 54 communicates with the first sensor member 52 to indicate the pawl 32 being in the ratchet releasing position.

In accordance with a further aspect, the method 1000 can further include a step 1600 of arranging the pawl release lever 34 to engage the pawl 32 during movement from the non-deployed position to the deployed position.

In accordance with a further aspect, the method 1000 can further include a step 1700 of arranging the second sensor member 54 for movement toward the second position against the bias of the biasing member 44 while the pawl 32 remains in the ratchet holding position.

In accordance with a further aspect, the method 1000 can further include a step 1800 of providing a carrier 32b supporting a rolling element 32c and arranging the rolling element 32c for rolling action between the ratchet 30 and the pawl 32.

In accordance with a further aspect, the method 1000 can further include a step 1900 of arranging a first bumper 35a to prevent the rolling element 32c from impacting the pawl 32 during movement of the pawl 32 from the ratchet releasing position to the ratchet holding position.

In accordance with a further aspect, the method 1000 can further include a step 1950 of arranging a second bumper 35b to prevent the rolling element 32c from contacting the pawl 32 after movement of the pawl 32 to the ratchet releasing position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a closure panel, comprising:
a housing member;
a ratchet configured for movement relative to said housing member between a striker capture position and a striker release position and biased toward said striker release position;
a pawl configured for movement relative to said housing member between a ratchet holding position, whereat said pawl maintains said ratchet in said striker capture position, and a ratchet releasing position, whereat said pawl releases said ratchet for movement of said ratchet to said striker release position; and
a pawl sensor assembly with a first sensor member fixed relative to said housing member and a second sensor member movable from a first position to a second position, when in said first position, said pawl sensor assembly indicates said pawl in said ratchet holding position, and when in said second position, said pawl sensor assembly indicates said pawl in said ratchet releasing position, said second sensor member moveable relative to said pawl and said housing member.

2. The latch assembly of claim 1, further including a biasing member configured to bias said second sensor member toward said first position.

3. The latch assembly of claim 2, wherein said second sensor member biases said pawl toward said ratchet holding position under the bias imparted by said biasing member.

4. The latch assembly of claim 3, further including a pawl release lever moveable from a non-deployed position, whereat said pawl is in said ratchet holding position, to a deployed position, whereat said pawl is moved conjointly with said second sensor member against the bias imparted by said biasing member to said ratchet releasing position, whereupon said second sensor member communicates with said first sensor member to indicate said pawl is in said ratchet releasing position.

5. The latch assembly of claim 4, further wherein said pawl release lever is configured to engage said pawl during movement from said non-deployed position to said deployed position.

6. The latch assembly of claim 2, wherein said second sensor member is moveable toward said second position against the bias of said biasing member while said pawl remains in said ratchet holding position.

7. The latch assembly of claim 6, wherein deformation of said housing member into engagement with said second sensor member causes said second sensor member to move toward said second position, with said pawl remaining in said ratchet holding position.

8. The latch assembly of claim 1, further including a carrier supporting a rolling element for rolling action between the ratchet and the pawl.

9. The latch assembly of claim 8, further including a first bumper configured to prevent the rolling element from impacting the pawl during movement of the pawl from the ratchet releasing position to the ratchet holding position.

10. The latch assembly of claim 9, further including a second bumper configured to prevent the rolling element from contacting the pawl after movement of the pawl to the ratchet releasing position.

11. The latch assembly of claim 1, wherein said first sensor member is a Hall sensor.

12. A method of constructing a latch assembly for a closure panel, comprising:
providing a housing member;
supporting a ratchet for movement relative to said housing member between a striker capture position and a striker release position and biased toward said striker release position;
supporting a pawl for movement relative to said housing member between a ratchet holding position, whereat said pawl maintains said ratchet in said striker capture position, and a ratchet releasing position, whereat said pawl releases said ratchet for movement of said ratchet to said striker release position; and
fixing a first sensor member of a pawl sensor assembly relative to said housing member; and
supporting a second sensor member of the pawl sensor assembly for movement relative to said first sensor member from a first position to a second position, such that when said second sensor member is in said first position, said pawl sensor assembly indicates said pawl is in said ratchet holding position, and when said second sensor member is in said second position, said pawl sensor assembly indicates said pawl is in said ratchet releasing position.

13. The method of claim 12, further including arranging a biasing member to bias said second sensor member toward said first position.

14. The method of claim 13, further including arranging said second sensor member to engage and bias said pawl toward said ratchet holding position under the bias imparted by said biasing member.

15. The method of claim 14, further including arranging a pawl release lever for movement from a non-deployed position, whereat said pawl is in said ratchet holding position, to a deployed position, whereat said pawl is moved conjointly with said second sensor member against the bias imparted by said biasing member to said ratchet releasing position, whereat said second sensor member communicates with said first sensor member to indicate said pawl being in said ratchet releasing position.

16. The method of claim 15, further including arranging said pawl release lever to engage said pawl during movement from said non-deployed position to said deployed position.

17. The method of claim 13, further including arranging said second sensor member for movement toward said second position against the bias of said biasing member while said pawl remains in said ratchet holding position.

18. The method of claim 12, further including providing a carrier supporting a rolling element and arranging the rolling element for rolling action between the ratchet and the pawl.

19. The method of claim 18, further including arranging a first bumper to prevent the rolling element from impacting the pawl during movement of the pawl from the ratchet releasing position to the ratchet holding position.

20. The method of claim 19, further including arranging a second bumper to prevent the rolling element from contacting the pawl after movement of the pawl to the ratchet releasing position.
